(19) United States
(12) Patent Application Publication
(10) Pub. No.: US 2024/0043325 A1
(43) Pub. Date: Feb. 8, 2024

(54) GEOPOLYMER COMPOSITIONS AND METHODS OF MAKING AND USING THE SAME

(71) Applicant: Arclin USA LLC, Roswell, GA (US)

(72) Inventors: Arun Narayan, Duluth, GA (US); Samuel Walter Lonberg, Fuquay Varina, NC (US); Morgan Higgins, Holly Springs, NC (US); Guillermo Jose Velarde, Cary, NC (US)

(73) Assignee: Arclin USA LLC, Roswell, GA (US)

(21) Appl. No.: 18/364,266

(22) Filed: Aug. 2, 2023

Related U.S. Application Data
(60) Provisional application No. 63/370,161, filed on Aug. 2, 2022.
(60) Provisional application No. 63/370,175, filed on Aug. 2, 2022.
(60) Provisional application No. 63/370,181, filed on Aug. 2, 2022.

(51) Int. Cl. C04B 12/00; C04B 12/04; C04B 28/00; C04B 40/02

(52) U.S. Cl. CPC C04B 12/005; C04B 12/04; C04B 28/006; C04B 40/0263; C04B 2201/50; C04B 2111/00508

(57) ABSTRACT

Geopolymer compositions, and methods of making and using the same are provided. Coatings and composite products prepared from geopolymer compositions are also provided.

### CROSS REFERENCE TO RELATED APPLICATIONS

This application claims priority to and benefit of U.S. Provisional Application Nos. 63/370,161, filed on Aug. 2, 2022, 63/370,175, filed on Aug. 2, 2022, and 63/370,181, filed on Aug. 2, 2022, all of which are incorporated by reference in their entirety.

### FIELD OF THE INVENTION

Embodiments described herein generally relate to geopolymers. More particularly, such embodiments relate to geopolymer compositions, methods of making and using geopolymer compositions, coatings prepared from geopolymer compositions and the composite products.

### BACKGROUND OF THE INVENTION

Adhesives, coating, overlays and paints used in the building products arena that are thermoset and/or thermoplastic based have a wide array of applications and can be tailored/easy to use. Covalently cross-linked thermosetting/thermoplastic polymers with tunable solvent resistance, mechanical properties, and load carrying ability have a wide range of applications in end-markets such as, aerospace, transportation, construction, but they are not fire retardant, thus causing safety limitations. Synthesizing high-performance “inorganic based/formaldehyde free alternatives” to thermosetting and thermoplastic adhesives, coatings, paints and thermosetting formaldehyde based thermosets with excellent fire retardant properties accompanied with mechanical properties is still considered a “work in progress”. The objective here is to develop a stand-alone technology or pre-mix additive(s) that can completely replace or enhance existing adhesives, overlays, coating & paint technology(ies) (Epoxy based, polyurethane based, polyurea based, unsaturated polyester resin based, isocyanate based, polysulfide based, neoprene based, asphaltic, oleoresinous based, acrylic/cyanoacrylates based, silicone based, lignin/tannin based, polyol based, protein based, and formaldehyde based thermoset/thermoplastic resins) and their end application properties.

Therefore, it is an object of the invention to provide geopolymer compositions, and methods of making and using geopolymer compositions.

It is another object of the invention to provide coatings prepared from geopolymer compositions with improved mechanical properties.

It is still another object to provide composite products prepared from geopolymer compositions.

It is also object of the invention to provide geopolymer-based fire retardant wood-based composite construct and panels, fiberglass mat for roofing shingles, fiber reinforced geopolymers (a replacement for traditional formaldehyde or petro chemical based fiber reinforced plastics), glass reinforced facer mat, slit ribbons for tube and core manufacturing, rigid & thermal roofing underlayment, molded and/or extruded products such as refractory bricks and custom molded composites for aerospace and automotive applications, saturation and/or coating of paper and other carriers for use as an overlay in the lamination process.

### SUMMARY OF THE INVENTION

Geopolymer compositions, and methods of making and using geopolymer compositions are provided. Coatings and composite products prepared from geopolymer compositions are also provided.

In some embodiments, an alkali metal geopolymer composition, can include a metakaolin; an alkali silicate in a solvent; and at least one filler.

In other embodiments, a method for preparing an alkali metal geopolymer composition, can include measuring a metakaolin into a stainless steel planetary mixing bowl; adding an alkali silicate in a solvent into the bowl containing the metakaolin to form a mixture; stirring the mixture for about 15 minutes on medium speed to start a geopolymer reaction; adding a filler in three portions; stopping the stirring during the addition of a filler; stirring in between each addition of the filler for about 7 minutes to form a homogeneous slurry; pouring the slurry into a container; curing the slurry in an oven at 80° C.; cooling the slurry at room temperature to form the alkali metal geopolymer composition.

In one embodiment, a coating prepared from the alkali metal geopolymer compositions is provided.

In other embodiments, a method for preparing a composite product, can include contacting a plurality of substrates with an alkali metal geopolymer composition, wherein the composition can include a metakaolin; an alkali silicate in a solvent; and at least one filler; and curing the composition to produce a composite product.

In another embodiment, a composite product, can include a plurality of substrates and at least cured alkali metal geopolymer composition, wherein the composition can include a metakaolin; an alkali silicate in a solvent; and at least one filler.

### BRIEF DESCRIPTION OF THE DRAWINGS

FIG. 1 shows potassium geopolymer composition with multi-purpose sand content (wt. %) versus average maximum load (MPa).

FIG. 2 shows potassium geopolymer composition containing 70 wt. % of multi-purpose sand with varying cure time (hours) at 80° C. versus average maximum load (MPa).

FIG. 3 shows potassium geopolymer composition with multi-purpose sand and titanium dioxide filler with titanium dioxide content (wt. %) versus average flexural strength (MPa).

FIG. 4 shows potassium geopolymer composition containing 60.3 wt. % of multi-purpose sand +3 wt. % titanium dioxide with varying cure time (hours) at 80° C. versus average flexural strength (MPa).

FIG. 5 shows potassium geopolymer composition containing 60.3 wt. % of multi-purpose sand +5 wt. % titanium dioxide with varying cure time (hours) at 80° C. versus average flexural strength (MPa).

FIG. 6 shows that the flexural strength of the “Geopolymer Formulation” increases significantly with the increase in filler content (multipurpose sand content).

FIG. 7 shows that the flexural strength of the “Geopolymer Formulation” increases with the Al₂O₃ content but not significantly in comparison to the trend seen with the filler content increase.

FIG. 8 is a 3D plot seen that summarizing the results seen with the Pareto chart and the means plot results. FIG. 8 can be used to visualize the design space associated with this specific source of multipurpose sand and its specific interaction with the Al₂O₃ content in the Geopolymer Formulation. FIG. 8 demonstrates from the design of experiments (DOE) that higher multipurpose sand content and higher Al₂O₃ content providing higher flexural strength of the geopolymer composition.

### DETAILED DESCRIPTION OF THE INVENTION

### I. Definitions

The following terms are intended to have the meanings presented therewith below and are useful in understanding the description and intended scope of the present invention.

The articles “a” and “an” may be used herein to refer to one or to more than one (i.e., at least one) of the grammatical objects of the article. By way of example “an analogue” means one analogue or more than one analogue.

The term “about” as used herein, refers that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments. Additionally, in phrase “about X to Y,” is the same as “about X to about Y,” that is the term “about” modifies both “X” and “Y.”

The term “compound” as used herein, refers to salts, complexes, isomers, stereoisomers, diastereoisomers, tautomers, and isotopes of the compound or any combination thereof.

The term “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are used in their inclusive, open-ended, and non-limiting sense.

The term “effective,” as that term is used in the specification and/or claims, means adequate to accomplish a desired, expected, or intended result.

### II. Alkali Metal Geopolymer Compositions

The geopolymer binder compositions of the present invention are advantageous because they do not rely on petrochemical products. Therefore, they do not require any volatile organic solvents or emit any volatile organic compounds. Rather, they can be formulated only using water as a solvent. In addition, they do not have aging problems, are incombustible, anti-corrosive, possess high strength, and are environmental friendly. Furthermore, the geopolymer-containing filler particles have a good flowability.

Geopolymer binder compositions, and methods of making and using geopolymer binder composition are provided.

In some embodiments, an alkali metal geopolymer composition, can include a metakaolin; an alkali silicate in a solvent; and at least one filler.

In other embodiments, the alkali metal is selected from the group consisting of lithium, sodium, potassium, rubidium, cesium, and mixtures thereof.

In another embodiment, the alkali silicate is selected from the group consisting of potassium silicate, sodium silicate, and mixtures thereof.

In some embodiments, the solvent comprises an alkanol, an aromatic alcohol, and water. In one embodiment, the solvent is water.

In other embodiments, the filler is selected from the group consisting of multi-purpose sand, titanium dioxide, calcium carbonate, silicon dioxide, lignosulfonate, powdered graphite, cristoballite, feldspar, wollostonite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), cristoballite, feldspar, wollostonite, perlite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), and mixtures thereof.

In some embodiments, the metakaolin is present in an amount from about 5 wt % to about 50 wt % based on the total composition, preferably, the metakaolin is present in an amount from about 5 wt % to about 35 wt % based on the total composition and more preferably, the metakaolin is present in an amount from about 5 wt % to about 10 wt % based on the total composition.

In other embodiments, the alkali silicate is present in an amount from about 5 wt % to about 70 wt % based on the total composition, preferably, the alkali silicate is present in an amount from about 10 wt % to about 50 wt % based on the total composition and more preferably, the alkali silicate is present in an amount from about 20 wt % to about 40 wt % based on the total composition.

In another embodiment, the filler is present in an amount from 0 wt % to about 90 wt % based on the total composition, preferably, the filler is present in an amount from 20 wt % to about 80 wt % based on the total composition and more preferably, the filler is present in an amount from 50 wt % to about 75 wt % based on the total composition.

In one embodiment, two or more fillers are present.

In some embodiments, the filler has an average particle size from about 0.001 micron to about 5 mm, preferably, the filler has an average particle size from about 0.1 micron to about 100 microns, and more preferably, the filler has an average particle size from about 10 microns to about 75 microns.

In other embodiments, the composition is cured at a temperature of about 60° C. to about 100° C.

In one embodiment, the composition is cured at a temperature of about 80° C.

In another embodiment, the composition cure time ranges from about 5 min to about hours, preferably, the composition cure time ranges from about 30 min to about 7 hours, and more preferably, the composition cure time ranges from about 1 hour to about 5 hours.

In some embodiments, the composition has a viscosity of about 5 cP to about 100,000 cP at a temperature of about 25° C., preferably, the composition has a viscosity of about 100 cP to about 10,000 cP at a temperature of about 25° C., and more preferably, the composition has a viscosity of about 500 cP to about 5,000 cP at a temperature of about 25° C.

In further embodiments, the average flexural strength of the composition ranges from about 0.5 MPa to about 50 MPa, preferably, the average flexural strength of the composition ranges from about 5 MPa to about 30 MPa, and more preferably, the average flexural strength of the composition ranges from about 10 MPa to about 20 MPa.

In other embodiments, a method for preparing an alkali metal geopolymer composition, can include measuring a metakaolin into a stainless steel planetary mixing bowl; adding an alkali silicate in a solvent into the bowl containing the metakaolin to form a mixture; stirring the mixture for about 15 minutes on medium speed to start a geopolymer reaction; adding a filler in three portions; stopping the stirring during the addition of a filler; stirring in between each addition of the filler for about 7 minutes to form a homogeneous slurry; pouring the slurry into a container; curing the slurry in an oven at 80° C.; cooling the slurry at room temperature to form the alkali metal geopolymer binder composition.

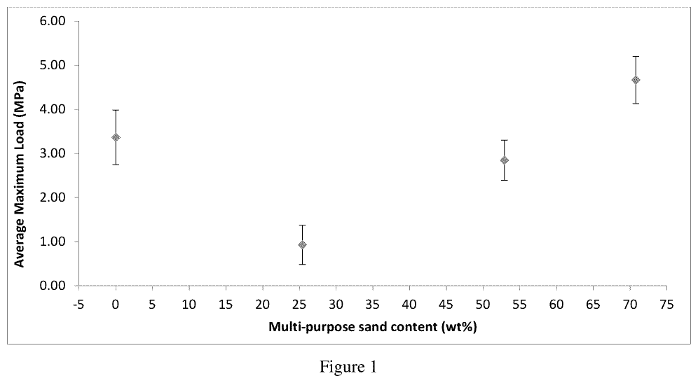

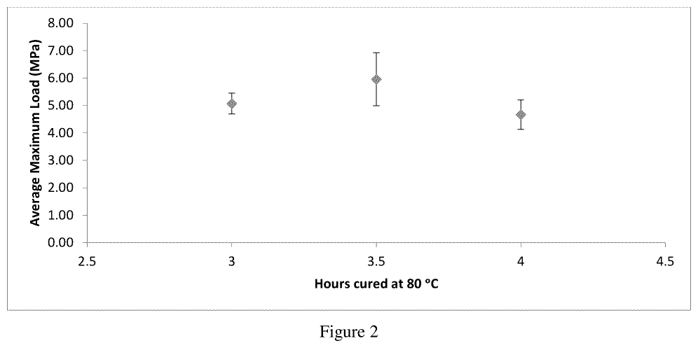

In some embodiments, potassium geopolymer composition can be prepared using metakaolin, potassium silicate solution and multi-purpose sand. FIG. 1 shows potassium geopolymer binder composition with multi-purpose sand content (wt. %) versus average maximum load (MPa). FIG. 2 shows potassium geopolymer binder composition containing 70 wt. % of multi-purpose sand with varying cure time (hours) at 80° C. versus average maximum load (MPa).

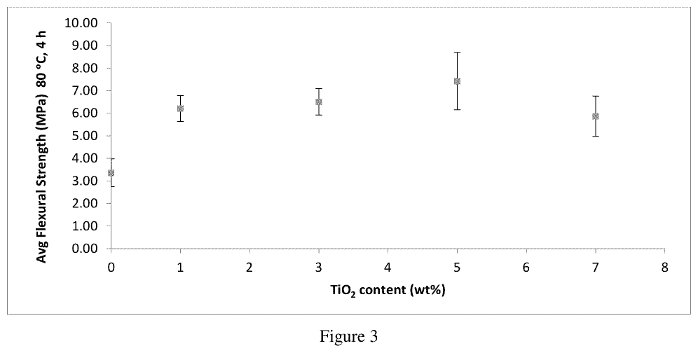

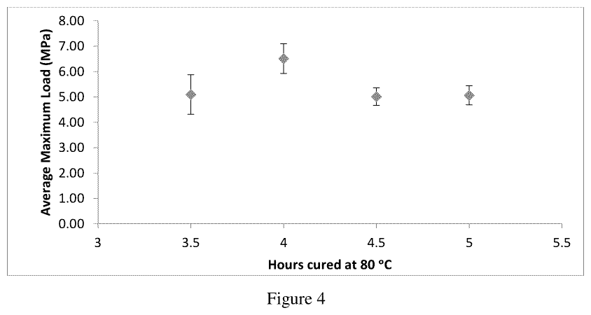

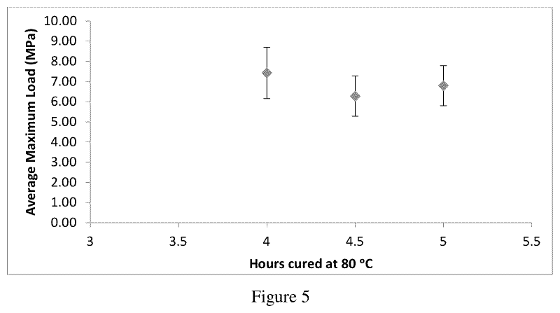

In other embodiments, potassium geopolymer composition can be prepared using metakaolin, potassium silicate solution, multi-purpose sand titanium dioxide (TiO₂). FIG. 3 shows potassium geopolymer binder composition with multi-purpose sand and titanium dioxide filler with titanium dioxide content (wt. %) versus average flexural strength (MPa). FIG. 4 shows potassium geopolymer binder composition containing 60.3 wt. % of multi-purpose sand +3 wt. % titanium dioxide with varying cure time (hours) at 80° C. versus average flexural strength (MPa). FIG. 5 shows potassium geopolymer binder composition containing 60.3 wt. % of multi-purpose sand +5 wt. % titanium dioxide with varying cure time (hours) at 80° C. versus average flexural strength (MPa).

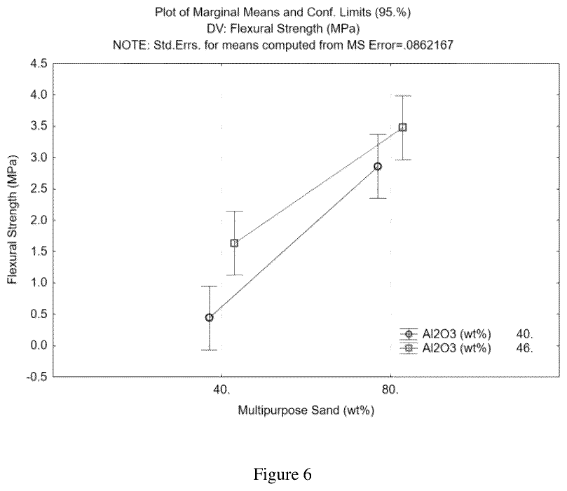

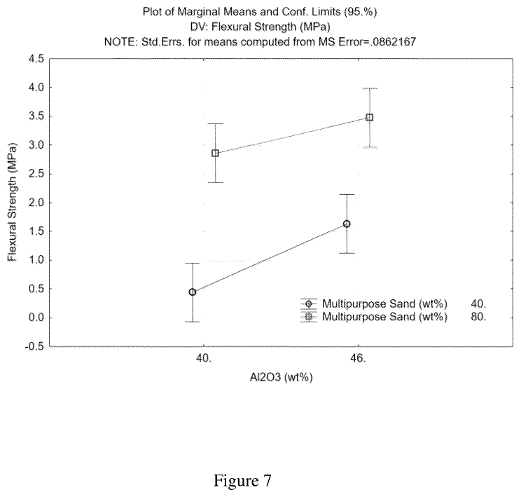

In further embodiments, potassium geopolymer composition can be prepared using metakaolin, potassium silicate solution and fumed silica (SiO₂) filler. FIG. 6 shows flexural strength of the “Geopolymer Formulation” increases significantly with the increase in filler content (multipurpose sand content). FIG. 7 shows flexural strength of the “Geopolymer Formulation” increases with the Al₂O₃ content but not significantly in comparison to the trend seen with the filler content increase.

### III. Coatings from the Alkali Metal Geopolymer Composition

The term “coating” refers to a coating in a form that is suitable for application to a substrate as well as the material after it is applied to the substrate, while it is being applied to the substrate, and both before and after any post-application treatments (such as evaporation, cross-linking, curing, and the like). The components of the coating compositions may vary during these stages.

The coatings comprise an alkali metal geopolymer binder compositions and may optionally comprise additional components, such as at least one carrier like filler, pigment, catalyst, or accelerator other than a binder. Coatings can be prepared using potassium geopolymer binder compositions of metakaolin, potassium silicate solution and fumed silica (SiO₂) filler and coating on a suitable substrate of choice.

Some non-limiting examples of types of binders include, but not limited to, polymeric binders. Polymeric binders (resins) can be thermoplastics or thermosets or modified natural alkyl resins and may be elastomers or fluoropolymers. Binders may also comprise monomers that can be polymerized before, during, or after the application of the coating to the substrate. Polymeric binders may be cross-linked or otherwise cured after the coating has been applied to the substrate. Examples of polymeric binders include polyethers such as poly(ethylene oxide)s (also known as poly(ethylene glycol)s, poly(propylene oxide)s (also known as poly(propylene glycol)s, and ethylene oxide/propylene oxide copolymers, cellulosic resins (such as ethyl cellulose, ethyl hydroxyethyl cellulose, carboxymethyl cellulose, cellulose acetate, cellulose acetate propionates, and cellulose acetate butyrates), and polyvinyl butyral, polyvinyl alcohol and its derivatives, ethylene/vinyl acetate polymers, acrylic polymers and copolymers, styrene/acrylic copolymers, styrene/maleic anhydride copolymers, isobutylene/maleic anhydride copolymers, vinyl acetate/ethylene copolymers, ethylene/acrylic acid copolymers, polyolefins, polystyrenes, olefin and styrene copolymers, urethane resins, isocyante resins. epoxy resins, acrylic latex polymers, polyester acrylate oligomers and polymers, polyester diol diacrylate polymers, UV-curable resins, and polyamide, including polyamide polymers and copolymers.

The coating industry is a material-intensive manufacturing industry. Materials which might be harmful to both humans and the environment are used in the manufacturing of most organic coatings. Harmful and hazardous materials used in the production process or in and after the preparation of the organic coating might volatilize into the atmosphere. The adverse impact on the environment resulting from the aforementioned materials has attracted global attention. In addition, the manufacture of organic coatings also consumes large quantities of natural resources, especially petroleum resources. The study of inorganic coatings has therefore been focused on. Inorganic coatings have many advantages. They are environmentally friendly, functional and have both technical and economic advantages. For example, sodium, potassium as well as lithium silicate resin cements, silica sols, phosphates and polysiloxanes are inorganic coating components.

The concept of geopolymers was brought up by Joseph Davidovits in the 1970s. The gist of this concept is an aluminum silicate inorganic polymer formed by geochemistry. The geopolymer has a network-like structure of amorphous inorganic polymer which has excellent adhesive properties, and especially shows a high bond strength in an early stage. Geopolymers also have the properties of good acid resistance, alkali resistance, seawater and high temperature resistance. Due to their high degree of compactness, ability of impermeability and antifreeze properties and especially excellent interface coalescence, geopolymers can be combined with different base materials to form a solid surface which can maintain long-term volume stability.

A wide range of products can be created by using geopolymers. Coatings are one of them. Coatings are decorative, protective and functional products. The majority thereof should have a desirable color. Therefore, white metakaolin as an aluminum silicate polymer can be provided for a white coating matrix, which also helps preparing bright colors. The color of the coating prepared from the geopolymer binder compositions according to the invention can be adjusted by incorporating one or more colorants such as organic or inorganic pigments or dyes into the geopolymer binder compositions. The type and amounts of the colorants can be chosen by a skilled person according to the requirements and are not restricted as long as the advantages of the invention are not impaired. As will be explained below, the coatings of the present invention can be used for various purposes. In order to modify the properties of the coating according to the needs, the geopolymer binder compositions can contain one or more optional components. The type and amount of the optional components will depend on the ultimate use of the geopolymer composition and are not particularly restricted. Examples of typical optional components are toughening agents, dispersing agents, plasticizers, levelling agents, and thickening agents. Furthermore, one or more functional agents which modify the properties of the geopolymer coating according to the intended use can be additionally contained in the geopolymer binder compositions.

Examples of such functional agents include, but not limited to, fire flame retardant agents (e.g., expanded graphite, melamine, hydrated glass powder, pentaerythritol, aluminum hydroxide); antimony trioxide, spherical closed cell expanded perlite, expanded vermiculite, fly ash particles, hollow glass beads, ceramic fiber powder, rockwool fiber powder); anti-rust agents (e.g., micaceous iron oxide, zinc metal, zinc powder, zinc oxide, glass flakes); antimicrobial agents (e.g., Ag₃PO₄—Zn₃(Pa_{-I})₂, (Ag—Zn) antimicrobial powder); stealth agent (e.g., high temperature ceramic metal oxide powder (cobalt, manganese, nickel, iron, barium, and zinc), iron carbonyl); conductive agents (e.g., iron carbonyl powder, silver-copper, silver-nickel, silver glass powder, silver mica powder); heat agent (e.g., aluminum powder, stainless steel powder); lubricants (e.g., graphite phosphate tablets, (MoS₂)); metal protective agent (e.g., alkali glass powder, silicon carbide powder); antifouling agents (e.g., cuprous oxide, capsaicin); temperature indication agent (e.g., Cu₂(HgI₄), COC₁₂ six-tetramine); and anti-radiation agent (e.g., PbO, BaSO₄, Fe₂O₃). Both the types and the amounts of the functional agent can be selected by a skilled person based on his general knowledge of the field.

The composition according to the present invention can be used to prepare a wide variety of coatings. Examples of possible coatings include, but not limited to, anti-crack architectural coatings, waterproof architectural coatings, zinc-rich coatings, anti-crack insulation coatings, waterproof insulation coatings, fire resistant coatings, anti-rust coatings, anti-mildew coatings, stealth coatings which are invisible to radar waves, conductive coatings, heat-proof coatings, lubricating coatings, antioxidant and anti-oxidation coatings, anti-pollution coatings, temperature indication coatings, anti-radiation coatings, and waterproof coatings. The coatings can be suitable for indoor and/or outdoor applications. If desired the coatings can be flexible.

In some embodiments, the deposition of an alkali metal geopolymer compositions onto the substrate is carried out by drop-cast, spray-cast, spin coating, dip coating, flow coating, knife coating, curtain coating, slot coating, brushing, dipping, spreading, spraying, wiping, or combinations thereof.

Coatings prepared from the geopolymer compositions are also provided.

In one embodiment, a coating is prepared from an alkali metal geopolymer compositions.

In another embodiment, the total thickness of the coating is from about 0.5 gsm to about 100 gsm, preferably, the total thickness of the coating is from about 5 gsm to about 25 gsm, and more preferably, the total thickness of the coating is from about 10 gsm to about 20 gsm.

In further embodiments, coatings can be prepared using potassium geopolymer compositions of metakaolin, potassium silicate solution and fumed silica (SiO₂) filler and these coatings can be deposited on a suitable substrate of choice.

### IV. Composite Products

A composite material is a material of two or more components with different properties, which together give the final product properties that none of its components have in themselves. Composite materials, or composite products for short, consist of a matrix, also called a binder, and a reinforcement, called a filler. Reinforcement is a discontinuous component of the composite that is harder, stiffer and significantly stronger than the matrix. The matrix is a continuous component of the composite that connects the reinforcement. The matrix protects the reinforcement from external influences and prevents its damage.

Geopolymer materials or geopolymers are among the ceramic materials. It belongs to the aluminosilicates. Their advantage over traditional ceramic materials is their preparation at room temperature and very low shrinkage during maturation. Geopolymers excel in their resistance to temperatures higher than 1100° C. and chemical resistance. Geopolymers usually consist of a geopolymeric binder forming a matrix and a filler that has a reinforcing function. Geopolymeric binders are covalently bonded mineral polymers. Fillers in conjunction with a geopolymic binder generally give the resulting composite stiffness and strength, particularly if the chosen filler is reactive in nature and can participate in the geopolymerization reaction. However, a wide range of other materials can be incorporated into the structure of geopolymers, which then play a very significant role not only in their resulting mechanical properties, but also in their thermodynamic properties.

Composite products prepared from geopolymer compositions are also provided.

In other embodiments, a method for preparing a composite product, can include contacting a plurality of substrates with an alkali metal geopolymer composition, wherein the composition can include a metakaolin; an alkali silicate in a solvent; and at least one filler; and curing the composition to produce a composite product.

In some embodiments, the composition is cured at a temperature of about 60° C. to about 100° C.

In one embodiment, the composition is cured at a temperature of 80° C.

In another embodiment, a composite product, can include a plurality of substrates and at least cured alkali metal geopolymer composition, wherein the composition can include a metakaolin; an alkali silicate in a solvent; and at least one filler.

In some embodiments, the plurality of substrates can include glass fibers, cellulosic fibers, ceramic fibers, carbon fibers, mineral fibers, plastic fibers, polymeric fibers, synthetic fibers, fiber sheets, fabric, a fiber web, or combinations thereof.

In further embodiments, the product can include fiberglass product, wood product, paper product, or combinations thereof.

In certain embodiments, potassium geopolymer based composite product can be prepared using composition of metakaolin, potassium silicate solution and fumed silica (SiO₂) filler and coating on a suitable substrate of choice.

### V. Industrial Applications

The present invention is about specialty product(s) that are based on “hybrid technology,” which is a combination of various tailor made “geopolymers” with existing adhesives, overlays, coatings, and paint technologies along with various substrates. An alkali metal geopolymer composition, coatings and composite products prepared from geopolymer compositions of the present invention offer several industrial applications including, but not limited to, fire retardant wood-based composite construct and panels, fiberglass mat for roofing shingles, fiber reinforced geopolymers (a replacement for traditional formaldehyde or petro chemical based fiber reinforced plastics), glass reinforced facer mat, slit ribbons for tube and core manufacturing, rigid & thermal roofing underlayment, molded and/or extruded products such as refractory bricks and custom molded composites for aerospace and automotive applications, saturation and/or coating of paper and other carriers for use as an overlay in the lamination process, use as caulks, paints, and adhesives, 3D printed products (including specialty parts and 3D printed home applications), and oil-field application in the form of water, gas, oil, and sand control and/or as an acidizing diverter.

Further, the present invention displays major benefits and vital utility in major industrial fields, which include, but not limited to, 1) Fire retardant (FR) capabilities will be greatly increased based on inorganic structure of geopolymer component. 2) Achieved optimal surface sealing that in turn results in reduced/no flame spread on the surface and increased resistance to scratching. 3) Most FR additives reduce end product mechanical strength when used in combination with an adhesive technology. Geopolymer binder plus filler of choice offers to achieve equivalent or better internal bond strength and modulus of rupture while exhibiting faster cure speeds and degree of cure with lower formaldehyde emissions. 4) The new geopolymer binder plus lignosulfonate and/or polyol stabilizer binder systems can be used as the novel no emissions/no-added formaldehyde resin system that performs better than incumbent technology. The geopolymer-based material can potentially be a good moisture barrier. 6) Geopolymer compositions offer high level of chemical resistance which can be used for industrial/chemical storage tank coatings and offer increased FR benefits to sequestered volatile waste.

Additionally, the combination of unique geopolymer formulation (that includes filler(s) of choice) by itself and in combination with an adhesive(s) (both thermoset and thermoplastic), coating(s) (both thermoplastic and thermoset) and paint(s) (both thermoplastic and thermoset) along with a substrate (such as fiberglass, carbon fiber, cellulose, wood etc) that exhibited unique and drastically improved finished product properties with no emissions or zero emissions with significantly improved FR characteristics.

### EXAMPLES

To provide a better understanding of the foregoing discussion, the following non-limiting examples are provided. Although the examples may be directed to specific embodiments, they are not to be viewed as limiting the invention in any specific respect.

### Example 1: General Procedure for the Preparation of Geopolymer Composition

Metakaolin was measured into a stainless steel planetary mixing bowl at ambient temperature (app 22° C.). Alkali silicate solution was then added to metakaolin. The mixture was stirred approximately 5 minutes at medium speed to initiate geopolymer reaction. Stirring was temporarily stopped to add filler of choice. Stirring was resumed at low to medium speed for another 5-10 minutes to ensure slurry is homogenous.

For formulations containing fumed silica, the initial binder slurry must be stirred longer (app 15 min) to ensure sufficient time for reaction of raw materials. Premature addition of fumed silica will disrupt the kinetics of the geopolymer reaction by introducing more silicate anion into the mixture.

### Example 2: Preparation of Potassium Geopolymer Composition with Multi-Purpose Sand Filler

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Multi-purpose sand was added in three portions, while stirring was stopped during the addition. Total stir time was approximately 7 minutes. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Multi-purpose sand weight % varies in the formulation. Table 1 below shows weight % of multi-purpose sand varies from 0 wt. % to 70 wt. % and corresponding average maximum load (MPa). FIG. 1 shows potassium geopolymer binder composition with multi-purpose sand content (wt. %) versus average maximum load (MPa).

TABLE 1
KGEOMPS

| Multi-purpose | Avg Load at | Load |
|---|---|---|
| sand content | Maximum Load | error |
| (wt %) | (MPa) | (MPa) |
| 0 | 3.36 | 0.62 |
| 25.4 | 0.93 | 0.44 |
| 52.9 | 2.85 | 0.45 |
| 70.8 | 4.66 | 0.54 |

Table 2 shows potassium geopolymer composition containing 70 wt. % of multi-purpose sand.

TABLE 2
KGEOMPS 70.0 Formulation

| | | | | | | | Amount | Amount |
|---|---|---|---|---|---|---|---|---|
| Reagent | | | Lot | | MR | | needed | added |
| # | Reagent | Supplier | # | WR | (Si2O:M2O) | Wt % | (g) | (g) |
| 1 | Potassium | PQ Corp | C071 | — | 1.7 | 20.4 | 300 | 300.0 |
| | silicate | | 521K | | | | | |
| | solution | | 6 | | | | | |
| 2 | Metakaolin | BASF | 1020 | 45.9% | — | 8.8 | 129.4 | 129.4 |
| | | | 5G | Al₂O₃ | | | | |
| 3 | Multi- | Sakrete | — | 60- | — | 70.8 | — | 1042.4 |
| | purpose | | | 100% | | | | |
| | sand | | | quartz | | | | |

Table 3 shows potassium geopolymer composition containing 70 wt. % of multi-purpose sand with varying cure time (hours) at 80° C. and corresponding average maximum load (MPa).

TABLE 3
KGEOMPS 70.0

| Cure time | Average | Load |
|---|---|---|
| at 80 C. | Maximum Load | error |
| (h) | (MPa) | (MPa) |
| 3 | 5.07 | 0.38 |
| 3.5 | 5.96 | 0.97 |
| 4 | 4.66 | 0.54 |

FIG. 2 shows potassium geopolymer composition containing 70 wt. % of multi-purpose sand with varying cure time (hours) at 80° C. versus average maximum load (MPa).

### Example 3: Preparation of Potassium Geopolymer Composition with Multi-Purpose Sand and TiO₂ Filler

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Multi-purpose sand was added in three portions, while stirring was stopped during the addition. Total stir time was approximately 7 minutes. Titanium dioxide (TiO₂) was added in one portion to the mixing bowl and mixed vigorously to combine thoroughly. The mixture was stirred additional 5 minutes. The mixture was whitish beige in color. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Titanium dioxide content weight % varies in the formulation. Table 4 below shows weight % of titanium dioxide varies from 0 wt. % to 7 wt. % and corresponding average flexural strength (MPa). FIG. 3 shows potassium geopolymer composition with multi-purpose sand and titanium dioxide filler with titanium dioxide content (wt. %) versus average flexural strength (MPa).

TABLE 4

| TiO₂ | Avg Flexural | Flexural |
|---|---|---|
| content | Strength | strength Error |
| (wt %) | (MPa) | (MPa) |
| 0 | 3.36 | 0.62 |
| 1 | 6.21 | 0.57 |
| 3 | 6.51 | 0.59 |
| 5 | 7.43 | 1.27 |
| 7 | 5.87 | 0.89 |

Table 5 shows potassium geopolymer composition containing 60.3 wt. % of multi-purpose sand +3 wt. % titanium dioxide.

TABLE 5
KGEOMPS60.3 + 3% TiO₂ Formulation

| Reagent | | | | | | | Amount | Amount |
|---|---|---|---|---|---|---|---|---|
| # | Reagent | Supplier | Lot # | WR | MR | Wt % | needed (g) | added (g) |
| 1 | Potassium | PQ Corp | C071521K6 | — | 1.7 | 20.2 | 300 | 299.9 |
| | silicate | | | | | | | |
| | solution | | | | | | | |
| 2 | Metakaolin | BASF | 10205G | 45.9% | — | 8.7 | 129.4 | 129.4 |
| | | | | Al₂O₃ | | | | |
| 3 | Multi- | Sakrete | — | 60-100% | — | 67.7 | 1000 | 1007.6 |
| | purpose sand | | | quartz | | | | |
| 4 | TiO₂ | Arclin | Yellow | — | — | 3.4 | 49.5 | 50.7 |
| | | CA | | | | | | |

Table 6 shows potassium geopolymer composition containing 60.3 wt. % of multi-purpose sand +3 wt. % titanium dioxide with varying cure time (hours) at 80° C. and corresponding average flexural strength (MPa).

TABLE 6
KGEOMPS60.3 + 3% TiO₂

| Cure time | Average | Flexural |
|---|---|---|
| at 80 C. | Flexural | strength |
| (h) | Strength (MPa) | error (MPa) |
| 3.5 | 5.10 | 0.78 |
| 4 | 6.51 | 0.59 |
| 4.5 | 5.02 | 0.35 |
| 5 | 5.06 | 0.38 |

FIG. 4 shows potassium geopolymer composition containing 60.3 wt. % of multi-purpose sand +3 wt. % titanium dioxide with varying cure time (hours) at 80° C. versus average flexural strength (MPa).

Table 7 shows potassium geopolymer composition containing 60.3 wt. % of multi-purpose sand +5 wt. % titanium dioxide.

TABLE 7
KGEOMPS + 5% TiO₂ Formulation

| Reagent | | | | | | | Amount | Amount |
|---|---|---|---|---|---|---|---|---|
| # | Reagent | Supplier | Lot # | WR | MR | Wt % | needed (g) | added (g) |
| 1 | Potassium | PQ Corp | C071521K6 | — | 1.7 | 19.8 | 300 | 300 |
| | silicate | | | | | | | |
| | solution | | | | | | | |
| 2 | Metakaolin | BASF | 10205G | 45.9% | — | 8.5 | 129.4 | 129.4 |
| | | | | Al₂O₃ | | | | |
| 3 | Multi- | Sakrete | — | 60-100% | — | 66.7 | 1000 | 1012.9 |
| | purpose sand | | | quartz | | | | |
| 4 | TiO₂ | Arclin | Yellow | — | — | 5.0 | 75.23 | 76.40 |
| | | CA | | | | | | |

Table 8 shows potassium geopolymer composition containing 60.3 wt. % of multi-purpose sand +5 wt. % titanium dioxide with varying cure time (hours) at 80° C. and corresponding average flexural strength (MPa).

TABLE 8
KGEOMPS60.3 + 5% TiO₂

| Cure time | Average Flexural | Flexural |
|---|---|---|
| at 80 C. | Strength | strength error |
| (h) | (MPa) | (MPa) |
| 4 | 7.43 | 1.27 |
| 4.5 | 6.27 | 1.00 |
| 5 | 6.79 | 0.99 |

FIG. 5 shows potassium geopolymer composition containing 60.3 wt. % of multi-purpose sand +5 wt. % titanium dioxide with varying cure time (hours) at 80° C. versus average flexural strength (MPa).

### Example 4: Preparation of Potassium Geopolymer Composition with Fumed Silica (SiO₂) Filler

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Fumed silica added to binder slurry, ranging from 1-10 wt %, while stirring was stopped during the addition. The mixture was stirred on setting 1 (lowest speed) and gradually increased to setting 9 (medium-high speed) to ensure homogenization of reactants and eliminate clumps of filler. Resultant slurry was stirred for a total of 15 minutes. The slurry was then poured in a plastic bottle.

Table 9 shows potassium geopolymer composition containing 7.5 wt. % of fumed silica.

TABLE 9
KGEOFS7.5 Formulation

| Reagent | | | | | | | Amount | Amount |
|---|---|---|---|---|---|---|---|---|
| # | Reagent | Supplier | Lot # | WR | MR | Wt % | needed (g) | added (g) |
| 1 | Potassium | PQ | C071521K6 | — | 1.7 | 64.6 | 300 | 300.0 |
| | silicate | Corp | | | (adjusted) | | | |
| | solution | | | | | | | |
| 2 | Metakaolin | BASF | 10205G | 45.9% | — | 27.9 | 129.4 | 129.4 |
| | | | | Al₂O₃ | | | | |
| 3 | Fumed silica | Sigma | MKBR7440V | — | — | 7.5 | 34.8 | 34.9 |

### Design of Experiments (DOE):

DOE was performed when evaluating the effect of 1) Al₂O₃ content in metakaolin species and 2) filler content in geopolymer mixtures on the resultant flexural strength.

### Results:

Both filler (Multipurpose Sand) and the binder (Al₂O₃) content in the “Geopolymer Formulation” have a statistically and significant/positive effect on the flexural strength of the final formulation. Both factors, filler and the binder are independent factors and do not have a statistically significant interaction effect with one another on the final flexural strength of the “Geopolymer Formulation.” There is no significant statistical difference seen with center points indicating that the experiment was conducted very consistently with minimal % error. There is no significant statistical difference seen between replicates indicating that the experiment was conducted very consistently with minimal % error.

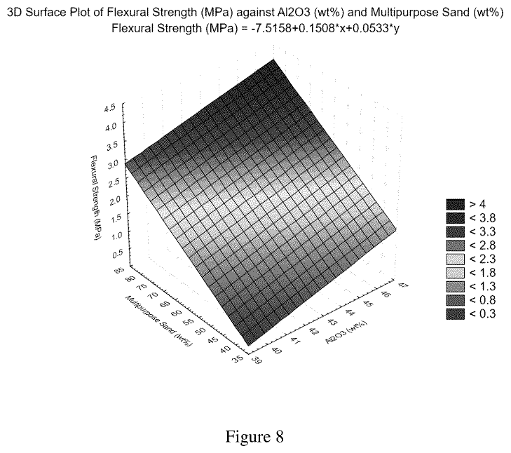

Flexural strength of the “Geopolymer Formulation” increases significantly with the increase in filler content (multipurpose sand content) as shown in FIG. 6. Further, flexural strength of the “Geopolymer Formulation” increases with the Al₂O₃ content but not significantly in comparison to the trend seen with the filler content increase as shown in FIG. 7. FIG. 8 is a 3D plot seen that summarizes/confirms the results seen with the Pareto chart and the means plot results. FIG. 8 can be used to visualize the design space associated with this specific/particular source of multipurpose sand and its specific interaction with the Al₂O₃ content in the “Geopolymer Formulation.” It can be concluded from DOE that high multipurpose sand content +high Al₂O₃ content=higher flexural strength.

### Example 5: General Procedure for Making Composite Product(s)

Potassium geopolymer binder composition with 2-10 wt. % fumed Silica (SiO₂) was coated on substrate of choice using either a grooved roller or a paint roller. For single-sided coats, the coated substrate was cured in an 80° C. oven for 15 minutes. For double-sided coats, the substrate was first cured for 5 minutes at 80° C. to eliminate tack, and then cured for 15 minutes after coating application on the opposite side. For double coats on a single side of the substrate, the substrate was let to stand at ambient temperature for 10-15 minutes after the first coat to eliminate tack. After application of the second coat, the substrate was then cured for 15 minutes at 80° C.

### Example 6: Preparation of Sodium Geopolymer Composition

Metakaolin was measured into stainless steel planetary mixing bowl. Sodium silicate solution was measured into disposable plastic cup. Sodium silicate solution was poured into mixing bowl and briefly stirred with rubber spatula to wet ingredients. The mixture was stirred with whisk attachment for 15 minutes on medium speed to start geopolymer reaction. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. and cured for 4 h. After removing from the oven, samples were allowed to cool for 30 minutes before de-molding. Samples were evaluated with 3-point bend test.

### Example 7: Preparation of Potassium Geopolymer Composition with Feldspar Filler (42 wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Feldspar filler (42 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 10 shows potassium geopolymer composition containing 42 wt. % of feldspar filler.

TABLE 10

| | Reagent/ | | Composition | Total | Amount | Amount |
|---|---|---|---|---|---|---|
| Reagent | Supplier | Lot # | Notes | Wt % | needed (g) | used (g) |
| Potassium | KASIL 6 | C071521K6 | 65.7% H₂O, | 38.4 | 150 | 150 |
| silicate | (adjusted)/ | MH01182022 | SiO₂:K₂O = 1.7 | | | |
| solution | PQ Corp | | | | | |
| Metakaolin | MetaMax/ | 10205G | 45.9% Al₂O₃ | 19.2 | 74.85 | 74.8 |
| | BASF | | | | | |
| Feldspar | Minspar | | 67.9% SiO₂, | 42.4 | | 165.7 |
| | 250 | | 19.1% Al₂O₃ | | | |

Table 11 shows potassium geopolymer composition containing 42 wt. % of feldspar filler with corresponding width (m), thickness (m), thick² (m²), max load (N), flexural strength (Pa) and flexural strength (MPa).

TABLE 11
KGEO + Minspar250 (42 wt %)

| | | | | Max | Flexural | Flexural |
|---|---|---|---|---|---|---|
| | Width | Thickness | | Load | Strength | Strength |
| Sample | (m) | (m) | Thick² (m²) | (N) | (Pa) | (MPa) |
| 1 | 0.02981 | 0.01668 | 0.000278222 | 1034.6 | 9917119 | 9.92 |
| 2 | 0.03076 | 0.01863 | 0.000347077 | 1137.5 | 8470450 | 8.47 |
| 3 | 0.02997 | 0.01824 | 0.000332698 | 786.65 | 6272090 | 6.27 |
| | | | Avg | 986.25 | 8219886 | 8.22 |
| | | | StDev | 180.35 | 1835387 | 1.84 |

### Example 8: Preparation of Potassium Geopolymer Composition with Perlite Filler (48 wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Perlite filler (48 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 12 shows potassium geopolymer composition containing 48 wt. % of perlite filler.

TABLE 12

| | Reagent/ | | Composition | Total | Amount | Amount |
|---|---|---|---|---|---|---|
| Reagent | Supplier | Lot # | Notes | Wt % | needed (g) | used (g) |
| Potassium | KASIL 6 | C071521K6 | 65.7% H₂O, | 34.7 | 150 | 150 |
| silicate | (adjusted)/ | MH01182022 | SiO₂:K₂O = 1.7 | | | |
| solution | PQ Corp | | | | | |
| Metakaolin | MetaMax/ | 10205G | 45.9% Al₂O₃ | 17.4 | 74.85 | 74.9 |
| | BASF | | | | | |
| Perlite Ore | PA1000 | | | 47.9 | | 206.6 |

Table 13 shows potassium geopolymer composition containing 48 wt. % of perlite filler with corresponding width (m), thickness (m), thick² (m²), max load (N), flexural strength (Pa) and flexural strength (MPa).

TABLE 13
KGEO + PA1000 (48 wt %)

| | | | | Max | Flexural | Flexural |
|---|---|---|---|---|---|---|
| | Width | Thickness | | Load | Strength | Strength |
| Sample | (m) | (m) | Thick² (m²) | (N) | (Pa) | (MPa) |
| 1 | 0.0302 | 0.01564 | 0.00024461 | 862.22 | 9279077.046 | 9.28 |
| 2 | 0.02764 | 0.01601 | 0.00025632 | 760.5 | 8533862.567 | 8.53 |
| 3 | 0.0282 | 0.01552 | 0.00024087 | 790.73 | 9254709.746 | 9.25 |
| 4 | 0.02745 | 0.01466 | 0.000214916 | 671.43 | 9048103.947 | 9.05 |
| 5 | 0.026 | 0.0137 | 0.00018769 | 571.65 | 9312855.281 | 9.31 |
| | | | Avg | 731.31 | 9085721.72 | 9.09 |
| | | | StDev | 112.47 | 325383.05 | 0.33 |

### Example 9: Preparation of Potassium Geopolymer Composition with Perlite Filler (55 wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Perlite filler (55 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 14 shows potassium geopolymer composition containing 55 wt. % of perlite filler.

TABLE 14

| | Reagent/ | | Composition | Total | Amount | Amount |
|---|---|---|---|---|---|---|
| Reagent | Supplier | Lot # | Notes | Wt % | needed (g) | used (g) |
| Potassium | KASIL 6 | C071521K6 | 65.7% H₂O, | 30.1 | 150 | 150 |
| silicate | (adjusted)/ | MH01182022 | SiO₂:K₂O = 1.7 | | | |
| solution | PQ Corp | | | | | |
| Metakaolin | MetaMax/ | 10205G | 45.9% Al₂O₃ | 15.1 | 74.85 | 74.8 |
| | BASF | | | | | |
| Perlite Ore | PA1000 | | | 54.8 | 274.82 | 273.1 |

Table 15 shows potassium geopolymer composition containing 55 wt. % of perlite filler with corresponding width (m), thickness (m), thick² (m²), max load (N), flexural strength (Pa) and flexural strength (MPa).

TABLE 15
KGEO + 55% PA1000

| | | | | Max | Flexural | Flexural |
|---|---|---|---|---|---|---|
| | Width | Thickness | | Load | Strength | Strength |
| Sample | (m) | (m) | Thick² (m²) | (N) | (Pa) | (MPa) |
| 1 | 0.03229 | 0.01877 | 0.000352313 | 1185.7 | 8286008.191 | 8.29 |
| 2 | 0.032 | 0.01862 | 0.000346704 | 1065.6 | 7635755.416 | 7.64 |
| 3 | 0.03219 | 0.01783 | 0.000317909 | 864.63 | 6716975.524 | 6.72 |
| 4 | 0.03251 | 0.01787 | 0.000319337 | 855.18 | 6548752.687 | 6.55 |
| 5 | 0.03185 | 0.01735 | 0.000301023 | 793.6 | 6580522.719 | 6.58 |
| | | | Avg | 894.75 | 6870501.59 | 6.87 |
| | | | StDev | 118.17 | 515361.94 | 0.52 |

### Example 10: Preparation of Potassium Geopolymer Composition with Perlite (20 wt %) and Multipurpose Sand Filler (50 wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Perlite filler (20 wt %) was added to the mixture. The mixture was stirred for 5-10 minutes or until homogeneous. Multipurpose sand filler (50 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 16 shows potassium geopolymer composition containing perlite (20 wt %) and multipurpose sand (50 wt %) filler.

TABLE 16

| | Reagent/ | | Composition | Total | Amount | Amount |
|---|---|---|---|---|---|---|
| Reagent | Supplier | Lot # | Notes | Wt % | needed (g) | used (g) |
| Potassium | KASIL 6 | C071521K6 | 65.7% H₂O, | 19.5 | 150 | 149.9 |
| silicate | (adjusted)/PQ | MH01182022 | SiO₂:K₂O = 1.7 | | | |
| solution | Corp | | | | | |
| Metakaolin | MetaMax/BASF | 10205G | 45.9% Al₂O₃ | 9.7 | 74.85 | 75 |
| Perlite Ore | PA1000 | | | 19.1 | 149.9 | 147 |
| Multipurpose | Multipurpose | | 60-100% | 51.7 | 374.75 | 398.6 |
| Sand | Sand/Sakrete | | quartz | | | |

Table 17 shows potassium geopolymer composition containing perlite (20 wt %) and multipurpose sand (50 wt %) filler with corresponding width (m), thickness (m), thick² (m²), max load (N), flexural strength (Pa) and flexural strength (MPa).

TABLE 17
KGEOMPS50 + 20% PA1000

| | | | | Max | Flexural | Flexural |
|---|---|---|---|---|---|---|
| | Width | | | Load | Strength | Strength |
| Sample | (m) | Thickness (m) | Thick² (m²) | (N) | (Pa) | (Mpa) |
| 1 | 0.03153 | 0.01585 | 0.000251223 | 892.11 | 8953710.173 | 8.95 |
| 2 | 0.03215 | 0.01679 | 0.000281904 | 832.01 | 7298158.739 | 7.3 |
| 3 | 0.03321 | 0.01757 | 0.000308705 | 925.79 | 7179053.924 | 7.18 |
| 4 | 0.0314 | 0.01569 | 0.000246176 | 689.79 | 7094282.647 | 7.09 |
| 5 | 0.03184 | 0.01726 | 0.000297908 | 913.72 | 7658180.847 | 7.66 |
| 6 | 0.03274 | 0.01981 | 0.000392436 | 1447.8 | 8958351.003 | 8.96 |
| 7 | 0.03262 | 0.01748 | 0.00030555 | 865.53 | 6903708.425 | 6.9 |
| | | | Avg | 938.11 | 7720777.97 | 7.72 |
| | | | StDev | 238.34 | 874432.98 | 0.87 |

### Example 11: Preparation of Potassium Geopolymer Composition with Perlite (40 wt %) and Multipurpose Sand Filler (30 wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Perlite filler (40 wt %) was added to the mixture. The mixture was stirred for 5-10 minutes or until homogeneous. Multipurpose sand filler (30 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 18 shows potassium geopolymer composition containing perlite (40 wt %) and multipurpose sand (30 wt %) filler.

TABLE 18

| | Reagent/ | | Composition | Total | Amount | Amount |
|---|---|---|---|---|---|---|
| Reagent | Supplier | Lot # | Notes | Wt % | needed (g) | used (g) |
| Potassium | KASIL 6 | C071521K6 | 65.7% H₂O, | 19.9 | 150 | 149.9 |
| silicate | (adjusted)/PQ | MH01182022 | SiO₂:K₂O = 1.7 | | | |
| solution | Corp | | | | | |
| Metakaolin | MetaMax/BASF | 10205G | 45.9% Al₂O₃ | 9.9 | 74.85 | 74.8 |
| Perlite Ore | PA1000 | | | 39.8 | 299.8 | 299.8 |
| Multipurpose | Multipurpose | | 60-100% | 30.4 | 224.9 | 229.5 |
| Sand | Sand/Sakrete | | quartz | | | |

Table 19 shows potassium geopolymer composition containing perlite (40 wt %) and multipurpose sand (30 wt %) filler with corresponding width (m), thickness (m), thick² (m²), max load (N), flexural strength (Pa) and flexural strength (MPa).

TABLE 19
KGEO + 40% PA1000/30% MPS

| | | | | Max | Flexural | Flexural |
|---|---|---|---|---|---|---|
| | Width | Thickness | | Load | Strength | Strength |
| Sample | (m) | (m) | Thick² (m²) | (N) | (Pa) | (Mpa) |
| 1 | 0.02898 | 0.01795 | 0.000322203 | 1235.6 | 10520048.48 | 10.52 |
| 2 | 0.03158 | 0.01964 | 0.00038573 | 1218 | 7949124.965 | 7.95 |
| 3 | 0.03024 | 0.01838 | 0.000337824 | 1037.1 | 8070769.832 | 8.07 |
| 4 | 0.03148 | 0.01926 | 0.000370948 | 1047 | 7127980.798 | 7.13 |
| 5 | 0.0298 | 0.01602 | 0.00025664 | 780.29 | 8111139.715 | 8.11 |
| 6 | 0.0294 | 0.014 | 0.000196 | 596.25 | 8226064.661 | 8.23 |
| | | | Avg | 985.71 | 8334188.08 | 8.33 |
| | | | StDev | 251.67 | 1141229.66 | 1.14 |

### Example 12: Preparation of Potassium Geopolymer Composition with Feldspar (40 wt %) and Multipurpose Sand Filler (30 wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Feldspar filler (40 wt %) was added to the mixture. The mixture was stirred for 5-10 minutes or until homogeneous. Multipurpose sand filler (30 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 20 shows potassium geopolymer composition containing feldspar (40 wt %) and multipurpose sand (30 wt %) filler.

TABLE 20

| | Reagent/ | | Composition | Total | Amount | Amount |
|---|---|---|---|---|---|---|
| Reagent | Supplier | Lot # | Notes | Wt % | needed (g) | used (g) |
| Potassium | KASIL 6 | C071521K6 | 65.7% H₂O, | 20.2 | 150 | 149.8 |
| silicate | (adjusted)/PQ | MH01182022 | SiO₂:K₂O = 1.7 | | | |
| solution | Corp | | | | | |
| Metakaolin | MetaMax/BASF | 10205G | 45.9% Al₂O₃ | 10.1 | 74.85 | 75 |
| FeIdspar | Minspar250/ | | 67.9% SiO₂, | 40.1 | 299.8 | 298.1 |
| | Imerys | | 19.1% Al₂O₃ | | | |
| | | | (90% FeIdspar, | | | |
| | | | 10% quartz) | | | |
| Multipurpose | Multipurpose | | 60-100% | 20.6 | 224.9 | 220.3 |
| Sand | Sand/Sakrete | | quartz | | | |

Table 21 shows potassium geopolymer composition containing feldspar (40 wt %) and multipurpose sand (30 wt %) filler with corresponding width (m), thickness (m), thick² (m²), max load (N), flexural strength (Pa) and flexural strength (MPa).

TABLE 21
KGEO + 40% Minspar250/30% MPS

| | | | | Max | Flexural | Flexural |
|---|---|---|---|---|---|---|
| | Width | Thickness | Thick² | Load | Strength | Strength |
| Sample | (m) | (m) | (m²) | (N) | (Pa) | (Mpa) |
| 1 | 0.02925 | 0.01565 | 0.000245 | 1002.7 | 11127140.95 | 11.13 |
| 2 | 0.03016 | 0.01533 | 0.000235 | 1052.4 | 11804084.81 | 11.8 |
| 3 | 0.02925 | 0.01497 | 0.000224 | 1053.1 | 12772245.87 | 12.77 |
| 4 | 0.03003 | 0.01606 | 0.000258 | 929.34 | 9538835.179 | 9.54 |
| 5 | 0.0293 | 0.017 | 0.000289 | 1012.6 | 9506914.51 | 9.51 |
| 6 | 0.02937 | 0.01526 | 0.000233 | 822.59 | 9561753.434 | 9.56 |
| | | | Avg | 978.79 | 10718495.79 | 10.72 |
| | | | StDev | 88.88 | 1397209 | 1.4 |

While in the foregoing specification this invention has been described in relation to certain embodiments thereof, and many details have been put forth for the purpose of illustration, it will be apparent to those skilled in the art that the invention includes additional embodiments and that certain of the details described herein can be varied considerably without departing from the basic principles of the invention. Although we have described the preferred embodiments for implementing our invention, it will be understood by those skilled in the art to which this disclosure is directed that modifications and additions may be made to our invention without departing from its scope.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. An alkali metal geopolymer composition, comprising:
a metakaolin;
an alkali silicate in a solvent; and
at least one filler.

2. The composition of claim 1, wherein the alkali metal is selected from the group consisting of lithium, sodium, potassium, rubidium, cesium, and mixtures thereof.

3. The composition of claim 1, wherein the alkali silicate is selected from the group consisting of potassium silicate, sodium silicate, and mixtures thereof.

4. The composition of claim 1, wherein the solvent comprises an alkanol, an aromatic alcohol, and water.

5. The composition of claim 1, wherein the filler is selected from the group consisting of multi-purpose sand, titanium dioxide, calcium carbonate, silicon dioxide, lignosulfonate, powdered graphite, cristoballite, feldspar, wollostonite, perlite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), and mixtures thereof.

6. The composition of claim 1, wherein the metakaolin is present in an amount from about 5 wt % to about 50 wt % based on the total composition.

7. The composition of claim 1, wherein the alkali silicate is present in an amount from about 5 wt % to about 70 wt % based on the total composition.

8. The composition of claim 1, wherein the filler is present in an amount from about 0 wt % to about 90 wt % based on the total composition.

9. The composition of claim 1, wherein two or more fillers are present.

10. The composition of claim 1, wherein the filler has an average particle size from about 0.001 micron to about 5 mm.

11. The composition of claim 1, wherein the composition is cured at a temperature of about 60° C. to about 100° C.

12. The composition of claim 1, wherein the composition cure time ranges from about 5 min to about 10 hours.

13. The composition of claim 1, wherein the composition has a viscosity of about 5 cP to about 100,000 cP at a temperature of about 25° C.

14. The composition of claim 1, wherein the average flexural strength of the composition ranges from about 0.5 MPa to about 50 MPa.

15. A coating is prepared from the alkali metal geopolymer composition of claim 1, wherein the total thickness of the coating is from about 0.5 gsm to about 100 gsm.

16. A method for preparing an alkali metal geopolymer composition, comprising:
measuring a metakaolin into a stainless steel planetary mixing bowl;
adding an alkali silicate in a solvent into the bowl containing the metakaolin to form a mixture;
stirring the mixture for about 15 minutes on medium speed to start a geopolymer reaction;
adding a filler in three portions;
stopping the stirring during the addition of a filler;
stirring in between each addition of the filler for about 7 minutes to form a homogeneous slurry;
pouring the slurry into a container;
curing the slurry in an oven at 80° C.; and
cooling the slurry at room temperature to form the alkali metal geopolymer composition.

17. A method for preparing a composite product, comprising:
contacting a plurality of substrates with an alkali metal geopolymer composition of claim 1; and
curing the composition to produce a composite product.

18. A composite product, comprising:
a plurality of substrates and at least cured alkali metal geopolymer composition, wherein the composition comprises:
a metakaolin;
an alkali silicate in a solvent; and
at least one filler.

19. The composite product of claim 18, wherein the plurality of substrates comprises glass fibers, cellulosic fibers, ceramic fibers, carbon fibers, mineral fibers, plastic fibers, polymeric fibers, synthetic fibers, fiber sheets, fabric, a fiber web, or combinations thereof.

20. The composite product of claim 18, wherein the product comprises fiberglass product, wood product, paper product, or combinations thereof.
